(19) United States
(12) Patent Application Publication
(10) Pub. No.: US 2016/0004817 A1
(43) Pub. Date: Jan. 7, 2016

(54) SYSTEMS AND METHODS FOR IDENTIFYING SIGNIFICANTLY MUTATED GENES

(71) Applicant: THE BROAD INSTITUTE INC., Cambridge, MA (US)

(72) Inventors: Michael Lawrence, Cambridge, MA (US); Gad Getz, Belmont, MA (US)

(21) Appl. No.: 14/854,682

(22) Filed: Sep. 15, 2015

Related U.S. Application Data
(63) Continuation-in-part of application No. PCT/US2014/028268, filed on Mar. 14, 2014.
(60) Provisional application No. 61/794,867, filed on Mar. 15, 2013.

(51) Int. Cl. G06F 19/22

(52) U.S. Cl. CPC G06F 19/22

(57) ABSTRACT

The invention relates to method for identifying significantly mutated genes includes determining a false discovery rate for each of the genes. The method may include estimating local mutation rates for the genes by converting each covariate to a centered and normalized score. The method may also include estimating a local background mutation rate for each of the genes, which may be estimated from silent and/or noncoding mutations of each of the genes itself. In some embodiments, the local background mutation rate may be estimated additionally from one or more neighbor genes in a covariate space. Related systems, techniques, and articles are also encompassed by the present invention.

### RELATED APPLICATIONS AND INCORPORATION BY REFERENCE

This application is a continuation-in-part of international patent application Serial No. PCT/US2014/028268 filed Mar. 14, 2014, and published as PCT Publication No. WO 2014/144032 on Nov. 6, 2014 and which claims the benefit of U.S. Provisional Patent Application No. 61/794,867, filed on Mar. 15, 2013, the contents of which are incorporated herein by reference in their entireties.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FEDERAL FUNDING LEGEND

The present disclosure was made with government support under Grant Nos. U24CA143845 and U24CA143867 awarded by the National Institutes of Health. The government has certain rights in the invention.

### FIELD OF THE INVENTION

The present application relates generally to the field of genome sequencing. More particularly, the application relates to systems and methods for identifying significantly mutated genes.

### BACKGROUND OF THE INVENTION

Major international projects are now underway aimed at creating a comprehensive catalog of all genes responsible for the initiation and progression of cancer. These studies involve sequencing of matched tumor-normal samples followed by mathematical analysis to identify those genes in which mutations occur more frequently than expected by random chance. A fundamental problem with cancer genome studies is that as the sample size increases, the list of putatively significant genes produced by current analytical methods burgeons into the hundreds. The list can include many implausible genes (such as those encoding olfactory receptors and the muscle protein titin), suggesting extensive false positive findings that overshadow true driver events.

Citation or identification of any document in this application is not an admission that such document is available as prior art to the present invention.

### SUMMARY OF THE INVENTION

In view of the foregoing, there is a need to provide a tool, which addresses the limitations of current systems and methods for DNA data analysis.

Embodiments of the present disclosure provide a solution, including computer systems and methods for identifying significantly mutated genes.

According to some embodiments of the present disclosure, a system, method, and non-transitory computer-readable medium are provided for determining significantly mutated genes. Computer memory (e.g. one or more databases) is provided that stores various input and output data. A computer system (e.g. including one or more processors) in communication with the computer memory is also provided. The computer system is configured to provide a graphical user interface for displaying, for example, user options, data, input, and output to a user.

In one aspect, the present disclosure provides a computer-implemented method for identifying one or more significantly mutated genes. In some embodiments, the method includes providing a first dataset including one or more mutations detected in a sequencing project which may comprise one or more genes and one or more subjects; providing a second dataset including a sequencing coverage achieved for each of the genes and the subjects; providing a third dataset including one or more genomic covariate data for each of the genes; and determining a false discovery rate for each of the genes to identify the one or more significantly mutated genes.

In some embodiments, determining a false discovery rate for each of the genes can include calculating a p-value for each gene and determining a false discovery rate for each of the genes by converting the p-values to q-values. Genes with about q≦0.1 can be identified as the one or more significantly mutated genes. In some embodiments, the method can further include one or more of: estimating local mutation rates for the genes; estimating a local background mutation rate for each of the genes; determining a patient specific background mutation rate by combining the local background mutation rates for each of the subject; determining a probability for each sample to have a mutation in one or more categories; generating an output including the determined probabilities and the false discovery rates.

In some embodiments, the local mutation rates can be estimated by converting each covariate to a centered and normalized score. In some embodiments, the local mutation rate can be estimated from silent and/or noncoding mutations of each of the genes itself, and can be estimated additionally from one or more neighbor genes in a covariate space. In some embodiments, the false discovery rate can be determined from the determined probability for each sample to have a mutation in one or more categories.

In another aspect, the present disclosure provides a computer-implemented method for identifying one or more significantly mutated genes including providing a plurality of genes from samples from patients, the plurality of genes which may comprise a plurality of mutations; scoring each mutation against a corresponding patient-specific background rate to obtain a gene score for each mutation; determining a null distribution for each gene score by convoluting across patients the patient-specific null distribution based on the patient-specific background rate; summarizing one or more events by projecting to a space of degrees corresponding to one or more categories of mutations based on a frequency of occurrence; and determining a probability for each sample to be of a particular degree based on the patient-specific background rate.

In some embodiments, the method can further include determining one or more p-values for mutation abundance for each gene. In some embodiments, the determining of one or more p-values can include determining a clustering p-value by randomly permuting one or more observed mutations one or more times and measuring a fraction of permutations in which one or more permuted mutations are at least as clustered in configuration as the observed mutations. In some embodiments, the method can further include determining a functional impact p-value by randomly permuting one or more observed mutations one or more times and measuring a fraction of permutations in which the permuted mutations are at least as enriched in one or more functionally important sites in the respective gene as the one or more observed mutations. In some embodiments, the method can further include combining the plurality of p-values into a single summary metric p-value.

In yet another aspect, the present disclosure provides a method for identifying one or more significantly mutated genes, including placing a plurality of genes in a covariate space; selecting a first gene from the plurality of genes and identifying one or more closest neighbors of the first gene in the covariate space; and determining a local background mutation rate of the one or more closest neighbors, excluding the first gene.

In some embodiments, the method can further include identifying one or more additional closest neighbors and determining an additional local background mutation rate of the one or more closest neighbors and the additional closest neighbors. In some embodiments, the method can further include determining a gene-specific contribution to the background mutation rate using a frequency of synonymous and noncoding mutations in the first gene plus its closest neighbors.

Computer program products are also described that may comprise non-transitory computer readable media storing instructions, which when executed by one or more data processor of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection (wired or peer-to-peer wireless) between one or more of the computing systems, etc.

The details of one or more variations of the subject matter described herein are set forth in the accompanying drawings and the description below. Other features and advantages of the subject matter described herein will be apparent from the description and drawings, and from the claims.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. Nothing herein is to be construed as a promise.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings:

FIG. 1 is a diagram illustrating a system in accordance with an exemplary embodiment of the present disclosure;

FIG. 2 is a process flow diagram illustrating a method in accordance with an exemplary embodiment of the present disclosure; and

FIG. 3 is a further process flow diagram illustrating a method in accordance with an exemplary embodiment of the present disclosure.

### DETAILED DESCRIPTION OF THE INVENTION

Recent cancer genome studies have led to the identification of scores of cancer genes, for example, in lung, breast, colorectal, pancreatic, glioblastoma, ovarian, head-and-neck, prostate, multiple myeloma, chronic lymphocytic leukemia, diffuse large B-cell lymphoma, and other cancers. Studies are now underway through The Cancer Genome Atlas (TCGA) (http://cancergenome.nih.gov/) and the International Cancer Genome Consortium (ICGC) (http://www.icgc.org/) to create a comprehensive catalog of significantly mutated genes across all major cancer types. The expectation has been that this list would converge on a finite set of genes that are the main causal drivers of carcinogenesis.

Alarmingly, recent results appear to show the opposite phenomenon: with large sample sizes, the list of apparently significant cancer genes grew rapidly and implausibly. For example, when prior analytical methods are applied to whole-exome sequence data from 178 tumor-normal pairs of lung squamous cell carcinomal 15, a total of 450 genes were found to be mutated at a significant frequency (e.g., false-discovery rate q<0.1). While the list contains some genes known to be associated with cancer, many of the genes seem highly suspicious based on their biological function or genomic properties. Almost a quarter (101/450) of the putative significant genes encode olfactory receptors. The list is also highly enriched for genes encoding extremely large proteins, including more than one-fifth of the 83 genes encoding proteins with >4,000 amino acids (p<10⁻¹¹, Fisher's exact test). These include the two longest human proteins, the muscle protein titin (36,800 amino acids) and the membrane-associated mucin MUC16 (14,500 amino acids), as well as another mucin (MUC4), cardiac ryanodine receptors (RYR2, RYR3), cytoskeletal dyneins (DNAH5, DNAH11), and the neuronal synaptic vesicle protein piccolo (PCLO). The prominence of these genes is not simply the consequence of their long coding regions, because the statistical tests already account for the larger target size. Furthermore, the list also contains genes with very long introns, including one-sixth of the 73 genes spanning a genomic region of >1 Mb (p<10⁻⁶), such as those encoding cub-and-sushi-domain proteins (CSMD1, CSMD3), and many neuronal proteins, such as the neurexins NRXN1, NRXN4 (CNTNAP2), CNTNAP4, and CNTNAP5, the neural adhesion molecule CNTN5, and the Parkinson protein PARK2. When similar analyses were performed for several other cancer types with many samples, similarly large lists were obtained, including many of the same genes.

After recognizing the problem of apparent false-positive findings, the published literature were reviewed and found that some of these potentially spurious genes have already cropped up in recently published cancer genome studies, for example: LRP1B in glioblastoma (GBM) and lung adenocarcinoma; CSMD3 in ovarian cancer; PCLO in diffuse large B-cell lymphoma (DLBCL); MUC16 in lung squamous carcinoma, breast cancer and DLBCL; MUC4 in melanoma; olfactory receptor OR2L13 in GBM; and TTN in breast cancer and other tumor types.

Current analytical approaches identify as significantly mutated those genes that harbor more mutations than expected given the average background mutation frequency for the cancer type. These methods employ a handful of parameters: an average overall mutation frequency for a cancer type and a few parameters about the relative frequencies of different categories of mutations (small insertions/deletions and transitions vs. transversions at CpG dinucleotides, other C:G basepairs and A:T basepairs). Average values of these parameters are typically estimated from the samples under study.

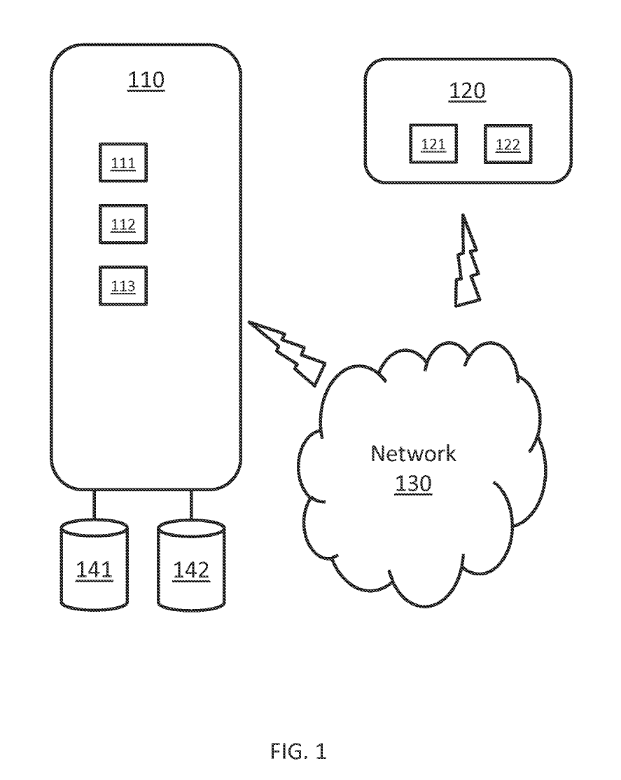

It is hypothesized that the problem may be due at least in part to heterogeneity in the mutational processes in cancer. While it is obvious that assuming an average mutation frequency that is too low will lead to spuriously significant findings, it is less well appreciated that using the correct average rate but failing to account for heterogeneity in the mutational process can also wreak havoc. To illustrate this point, two simple scenarios are compared, both sharing the same average mutation frequency: (a) constant frequency of 10 mutations per megabase (10/Mb) across all genes vs. (b) frequency of 4/Mb, 8/Mb and 20/Mb at 25%, 50% and 25% of genes, respectively (see FIG. 1). If one analyzes the second case under the erroneous assumption of a constant rate, many of the highly mutable genes will falsely be declared to be cancer genes. Notably, the problem grows with sample size: because the threshold for statistical significance decreases with sample size, modest deviations due to an erroneous model are declared significant. For the same reason, the problem is also more pronounced in tumor types with higher mutation rates. Heterogeneity in mutation frequencies across patients can also lead to inaccurate results, including the potential to produce both false-positive, as described above, and false-negative results if the baseline frequency is overestimated.

Accordingly, there is a need for systems and methods which employ a new integrated approach to identify significantly mutated genes, for example, in cancer. To this end, the present subject matter provides systems and methods which correct for variations by employing (i) patient-specific mutation frequency and spectrum, and/or (ii) gene-specific background mutation rates incorporating expression level (e.g. transcriptional activity) and replication timing. By incorporating mutational heterogeneity into the analysis, the present subject matter can eliminate most of the apparent artefactual findings and allow true cancer genes to rise to attention. Furthermore, by providing the ability to eliminate many obviously suspicious genes, the present subject matter enables analysis of, for example, large cancer collections, including combined data sets across many cancer types.

References will now be made to FIG. 1, showing a system in accordance with an exemplary embodiment of the present subject matter. As shown, system 110 includes one or more processors 111, one or more memories 112, and one or more modules 113 for identifying significantly mutated genes as will be discussed below. The system 110 may also include one or more database 141 and 142 for storing, e.g. input and output data. The system 110 can be configured to communicate with one or more additional devices (e.g. client computers 120) through a network 130 (e.g. using known network protocols). The additional devices may include one or more processors 121 and memories 122. The system 110 and/or the additional devices may include a user interface, e.g., for providing inputs and/or outputs from the system to the user. Such interface(s) may include one or more display devices (e.g., liquid crystal display (LCD) device of a personal or home computer, or a mobile phone display), and/or any other suitable output device(s).

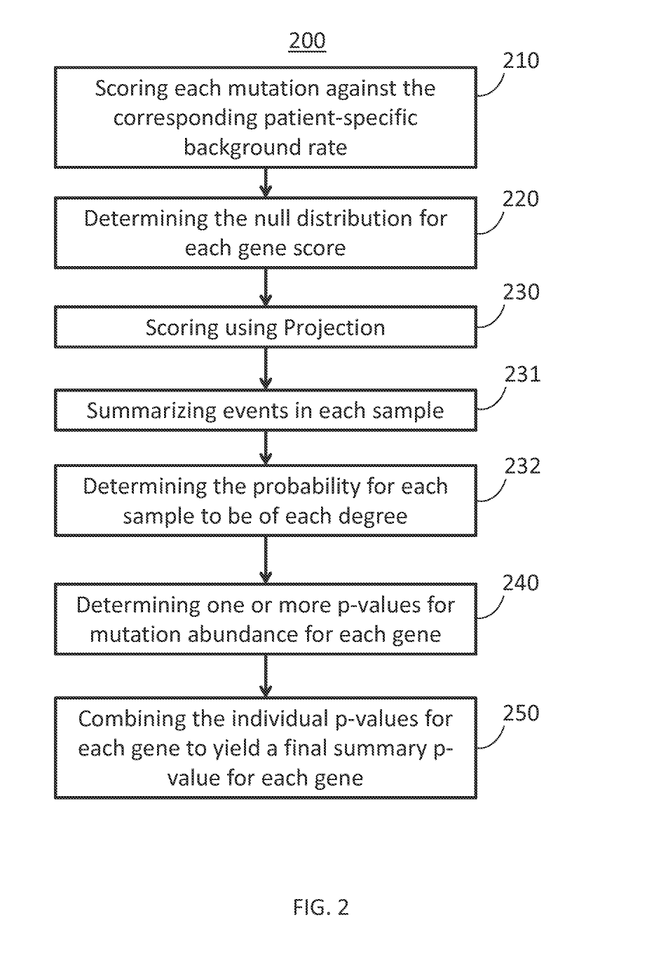

Referring now to FIG. 2, which shows a method in accordance with an exemplary embodiment of the present subject matter. At 210, every mutation can be scored against the corresponding patient-specific background rate μₚ in which it is observed. At 220, the null distribution for the gene's score can be calculated by convoluting across patients the patient-specific null distribution based on μₚ. At 230, a scoring technique called Projection can be used to prioritize genes that are mutated in many different samples, in preference to those having several mutations in the same sample. First, at 231, the events in each sample can be summarized by projecting to a space of degrees corresponding to the different categories of mutations it could have (or no mutations)—the lowest degree is associated with no mutations and the degrees increase with rarity of the event. The degree associated with each sample represents the rarest event observed in the sample. At 232, the probability for each sample to be of each degree can be computed based on μₚ, and the score associated with that degree is given by the −log (probability of the degree under the null hypothesis). As described above, the null distribution can then be calculated by convoluting the sample-specific nulls (which also depend on μₚ).

At 240, one or more p-values for mutation abundance for each gene can be determined. In some embodiments, this can include determining a covariate-based p-value for mutation abundance (pCV) for each gene, for example, by comparing the observed score to the null distribution. In some embodiments, 240 can include determining a “clustering” p-value (pCL) for mutation positional clustering for each gene by randomly permuting the observed mutations many times and measuring the fraction of permutations in which the permuted mutations are at least as clustered as in the observed configuration. This measures an orthogonal signal of positive selection that can reveal driver genes.

In some embodiments, 240 can include determining a “functional impact” p-value (pFN) for mutation functional impact for each gene by randomly permuting the observed mutations many times and measuring the fraction of permutations in which the permuted mutations are at least as enriched in functionally important sites in the gene as in the observed configuration. This measures an orthogonal signal of positive selection that can reveal driver genes. In some embodiments, different metrics of functional impact can be used, including the evolutionary conservation of the different positions in the gene.

In some embodiments, the plurality of p-values generated for each gene can be combined at 250 into a single summary metric p-value for each gene.

In some embodiments, one or more of the features shown in FIG. 2 can be omitted, substituted, and/or performed in different orders.

In some embodiments, gene-specific differences in background mutation rate can be accounted for. For example, the mutation frequency in different genes, categories, and patients, μ_{g,c,p} (where g represents the gene, c the category, and p the patient) can be approximated by using genomic covariates (such as, e.g. expression level and DNA replication time). For very long genes, the local background mutation rate (BMR) can be directly estimated from (a) synonymous mutations in the gene's coding sequence, and/or (b) noncoding mutations in the flanking UTR (Untranslated Region) and intronic sequences, safely beyond functional splice site mutations. For shorter genes, where there is not enough data to confidently estimate the local BMR, the binning approach—where genes are binned by estimated expression level, and an average mutation rate is calculated for each bin, with the observation that mutation rate generally decreases with increasing expression—can be extended.

In some embodiments of the present subject matter, expression data, averaged across many tissue types (e.g. in the Cancer Cell Line Encyclopedia) can be augmented with other gene characteristics observed empirically to co-vary with mutation rate, such as local DNA replication time, chromatin state (e.g. open vs. closed chromatin status measured by HiC mapping, or chromatin modifications measured by ChIP-Seq or other methods), local GC content, and local gene density. In some embodiments, gene expression levels and local replication time can be highly correlated across tissue types.

In accordance with the present subject matter, a general framework can be provided to encompass an arbitrary collection of covariates. In some embodiments, each gene can be placed in a high-dimensional covariate space, and the gene's nearest neighbors can be identified. A set of nearest neighbors surrounding the gene of interest (which is termed a bagel of genes, to reflect the fact that the gene itself is excluded and thus the set has a hole at its center) can be built up around the original gene, and the local BMR can be re-evaluated, e.g., by pooling the data across the genes in the bagel, gradually decreasing the uncertainty of the estimate as the total amount of genomic territory reflecting the genes in the bagel increases. In some embodiments, one or more stopping criteria can be imposed to balance the increased precision with the decreased accuracy (i.e. increased bias) that results from expanding outward to increasingly distant neighbors. In some embodiments, a gene-specific contribution to the BMR can be estimated using the frequency of synonymous and/or noncoding mutations in the gene plus its surrounding bagel. This gene-specific factor can be combined with patient- and/or category-specific factors to yield a final estimated distribution for the expected value of μ_{g,c,p}, calculated for each gene g, category c, and patient p combination. These μ_{g,c,p} can then be fed into the Projection method described above, which can be extended here to take into account, e.g., two (or more) mutations (instead of just one) in each patient, thus allowing an extra scoring opportunity for genes that have both alleles mutated in one or more patients (e.g. classic two-hit tumor suppressors like APC).

In some embodiments, the patient's nearest neighbors can be identified, and the bagel can be built up such that it contains data from only those neighbor patients.

In some embodiments, measurement error in the estimate of μ_{g,c,p} can be propagated by preserving the mutation and coverage counts separately (e.g. as x_{g,c,p} and X_{g,c,p} respectively) instead of merging them in a ratio (e.g. μ=x/X) and thereby losing the uncertainty in μ (i.e. error bars).

In some embodiments, the input data includes three (or more) files. For example, each file can be a tab-delimited text file with a header row. The files can include one or more of the following:

### Mutation Table

In some embodiments, this table can include information about the mutations detected in the sequencing project. It can list, e.g., one mutation per row, and the columns (e.g. named in the header row) can report several pieces of information for each mutation. The table (e.g. the columns) may include, for example, one or more of:
Hugo_Symbol=name of the gene that the mutation was in;
Tumor_Sample_Barcode=name of the patient that the mutation was in;
categ=number of category that the mutation was in (in some embodiments, the category must match those in the coverage table);
is_coding=1 (e.g. if the mutation in a coding region or splice-site) or 0 (e.g. if the mutation is in a noncoding flanking region); and
is_silent=1 (e.g. if the mutation is a synonymous change) or 0 (e.g. if the mutation is a coding change or is noncoding).

In some embodiments of the present subject matter, the category numbers in categ may include one or more of:
1. transition mutations at CpG dinucleotides;
2. transversion mutations at CpG dinucleotides;
3. transition mutations at C:G basepairs not in CpG dinucleotides;
4. transversion mutations at C:G basepairs not in CpG dinucleotides;
5. transition mutations at A:T basepairs;
6. transversion mutations at A:T basepairs; and
7. null+indel mutations, including, e.g. nonsense, splice-site, and indel mutations.

Other categorie(s), e.g. discovered in a mutation spectrum analysis can also be used.

### Coverage Table

In some embodiments, this table can include information about the sequencing coverage achieved for each gene and patient. For example, within each gene-patient bin, the coverage can be broken down further according to the category (e.g. A:T basepairs, C:G basepairs), and/or according to the zone (e.g. silent/nonsilent/noncoding). In some embodiments, the table (e.g. the columns) may include one or more of:
gene=name of the gene that this line reports coverage for;
zone=silent, nonsilent, or noncoding;
categ=number of the category that this line reports coverage for (e.g. must match the categories in the mutation table);
PATIENT1_NAME=number of covered bases for PATIENT1 in this gene, zone, and category;
PATIENT2_NAME=number of covered bases for PATIENT2 in this gene, zone, and category,
. . .
PATIENTnₚ_{_{—}}NAME=number of covered bases for PATIENTnₚ_{_{—}}NAME in this gene, zone, and category.

In some embodiments, the covered bases typically contribute fractionally to more than one zone depending on the consequences of mutating to each of three different possible alternate bases. For example, a particular covered C base may count ⅔ toward the nonsilent zone and ⅓ toward the silent zone, if mutation to A or G causes an amino acid change whereas mutation to T is silent (synonymous).

### Covariates Table

In some embodiments of the present disclosure, this file can include the genomic covariate data for each gene, for example expression levels and DNA replication times, that can be used to judge which genes are near to each other in covariate space. In some embodiments, the table (e.g. the columns) can include one or more of:
gene=name of the gene that this line reports coverage for;
COVARIATE1_NAME=value of COVARIATE1 for this gene;
COVARIATE2_NAME=value of COVARIATE2 for this gene;
. . .
COVIARATEnᵥ_{_{—}}NAME=value of COVIARATEnᵥ for this gene;
expr=expression level of this gene, e.g., averaged across many cell lines in the Cancer Cell Line Encyclopedia;
reptime=DNA replication time of this gene, e.g. ranging approximately from 100 (very early) to 1000 (very late);
hic=chromatin compartment of this gene, e.g. measured from HiC experiment, ranging approximately from −50 (very closed) to +50 (very open).

In some embodiments of the present disclosure, the gene and patient names must agree across the three tables. Similarly, in some embodiments, the categ category numbers must agree between the mutation table and the coverage table.

### Representation of Data Matrices:

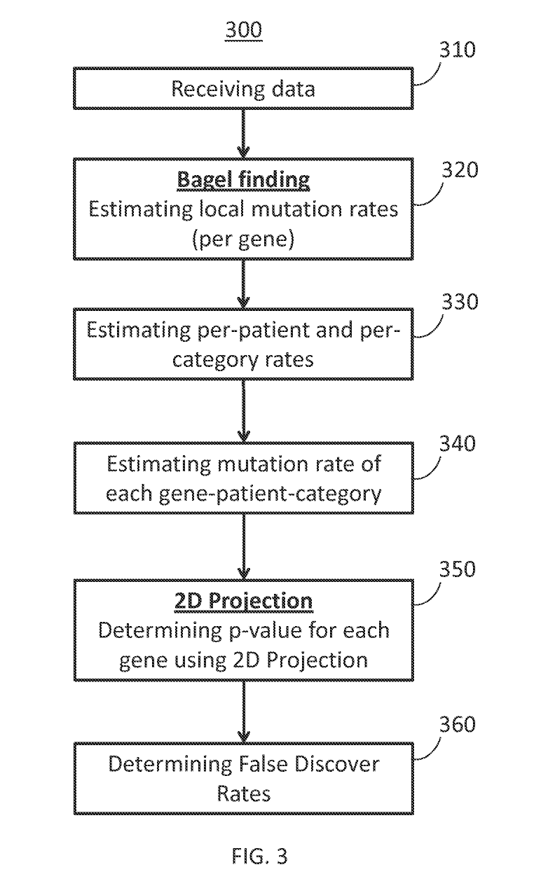

Reference will now be made to FIG. 3. At 310, the input data files (e.g. one or more of the Mutation Table, Coverage Table, and Covariates Table discussed above) can be loaded, e.g. from a disk, a database, or downloaded from other sources. The input data files can be converted in memory to, e.g., one or more of the following matrix forms. For example, matrix indices g, c, p, v range from 1 to ng, nc, np, nv, representing the total number of genes, categories, patients, and covariates respectively. The special case c=n_{c}+1 is used to represent the total counts. For mutation counts m, this is simply the sum across 1 to n_{c}. However, for coverage counts N, the total may be different than the sum across 1 to c, due to categories with overlapping territories, e.g. the territory of A:T mutations (which can happen at any A:T basepair) is included within the territory of indel mutations (which can happen at any basepair). In practice, the total coverage N will be equal to the coverage of the null+indel category.

### Mutation Counts:

In some embodiments of the present disclosure, the mutation table can be converted to the following exemplary matrices:
n_{g,c,p}^{silent}
n_{g,c,p}^{nonsilent}
n_{g,c,p}^{noncoding}

Each of these n matrices can represent, e.g., the number of mutations for a given gene g, category c, and patient p.

### Coverage Counts:

In some embodiments of the present disclosure, the coverage table can be converted to the following exemplary matrices:
N_{g,c,p}^{silent}
N_{g,c,p}^{nonsilent}
N_{g,c,p}^{noncoding}

Each of these N matrices can represent, e.g., the number of covered sequenced bases for a given gene g, category c, and patient p.

### Covariate Values:

In some embodiments of the present disclosure, the covariate table can be converted to the following exemplary matrix:
V_{v,g}
   where it represents the value of covariate v for gene g.

### Embedding of Genes in Covariate Space:

At 320, each covariate is converted to a Z-score, i.e. centered and normalized, e.g. by subtracting the mean and dividing by the standard deviation across genes. For example:

$${Z}_{v , g} = \frac{{V}_{v , g} - \frac{1}{{n}_{g}} {\sum }_{i = 1}^{{n}_{g}} {V}_{v , i}}{\sqrt{\frac{1}{{n}_{g} - 1} {\sum }_{j = 1}^{{n}_{g}} {( {V}_{v , j} - \frac{1}{{n}_{g}} {\sum }_{i = 1}^{{n}_{g}} {V}_{v , i} )}^{2}}}$$

Where each gene can be represented as a point in [symbol] ⁿ^{ᵥ} such that the coordinate v of gene g is equal to Z_{v,g}. Pairwise distances between genes can be calculated, e.g., in Euclidean fashion, such that the distance between genes i and j is:

$${D}_{i , j} = \sqrt{{\sum }_{v = 1}^{{n}_{v}} {( {Z}_{v , i} - {Z}_{v , j} )}^{2}}$$

### Local Regression Using Bagels:

At 330, the local BMR (background mutation rate) of each gene can be estimated from the silent and noncoding mutations of the gene itself, plus (if necessary) those of its neighbor genes in the covariate space. For example, silent and noncoding mutations can be pooled together across patients and categories to yield the following background (bkgd) counts:

$${n}_{g}^{bkgd} = {\sum }_{p = 1}^{{n}_{p}} ( {n}_{g , c + 1 , p}^{silent} + {n}_{g , c + 1 , p}^{noncoding} )$$

$${N}_{g}^{bkgd} = {\sum }_{p = 1}^{{n}_{p}} ( {N}_{g , c + 1 , p}^{silent} + {N}_{g , c + 1 , p}^{noncoding} )$$

It should be noted that, as mentioned above, here c+1 indicates the total counts across categories.

For each gene, a bagel of the closest neighboring genes in the covariate space can be chosen such that all of the genes in the bagel do not disagree with the BMR (background mutation rate) estimated for the gene itself. For example, the neighbor genes in the bagel of gene g can be represented as the largest set B_{g} that meets these criteria:

∀(i∈B_{g},j∉B_{g})(D_{g,i}≦D_{g,j})

and

∀(i∉B_{g})(Q_{i,g}≧Qₘᵢₙ)

and

|B_{g}|≦n_{B}^{max}

where n_{B}^{max} is the maximum neighbors, and Qₘᵢₙ is the minimum quality. In some embodiments, it may be defined to be, for example, n_{B}^{max} can be 50, and Qₘᵢₙ can be 0.05. These two parameters govern the size of the “bagel” of neighboring genes that will be used to estimate the BMR of each gene. For very sparse datasets (with very few mutations), it may be necessary to increase the maximum neighbors to allow larger bagels to be used. For example, it can be increased to 1000. With extremely sparse data, it may be possible for bagels to reach the size of many thousands of genes, in which each gene can be evaluated against the overall exome-wide BMR. Increasing the maximum neighbors will not affect the operation of the algorithm on dense datasets (with many mutations) because most genes will not expand to very large bagels. Indeed, at the opposite extreme, with datasets containing hundreds or thousands of patients, most genes will be sufficiently distinct from their neighbors that they will have empty bagels. The minimum quality can be set, for example, to 0.05 to halt bagel expansion upon reaching a neighbor gene that has a nominally significant difference in mutation rate from the central gene.

Q_{i, g} is the two-sided p-value for comparing the BMRs of gene i and the center gene g given their observed mutation and coverage counts.

Q_{i,g}=2 min(Q_{i,g}^{left},1−Q_{i,g}^{left})

Q_{i,g}^{left}=H_{C}(nᵢ^{bkgd},Nᵢ^{bkgd},n_{g}^{bkgd},N_{g}^{bkgd})

Hc is the cumulative form of the beta-binomial distribution H.

$${H}_{C} ( {n}_{1} , {N}_{1} , {n}_{2} , {N}_{2} ) = {\sum }_{n = 0}^{{n}_{1}} H ( n , {N}_{1} , {n}_{2} , {N}_{2} )$$

H is the beta-binomial probability mass function.

$$H ( {n}_{1} , {N}_{1} , {n}_{2} , {N}_{2} ) = ( \begin{matrix}{N}_{1} \\ {n}_{1}\end{matrix} ) \frac{B ( {n}_{1} + α , {N}_{1} - {n}_{1} + β )}{B ( α , β )} = \frac{Γ ( {N}_{1} + 1 ) Γ ( {N}_{2} + 2 ) Γ ( {n}_{1} + {n}_{2} + 1 ) Γ ( {N}_{1} + {N}_{2} - {n}_{1} - {n}_{2} + 1 )}{Γ ( {n}_{1} + 1 ) Γ ( {n}_{2} + 1 ) Γ ( {N}_{1} - {n}_{1} + 1 ) Γ ( {N}_{2} - {n}_{2} + 1 ) Γ ( {N}_{1} + {N}_{2} + 2 )}$$

$$where α = {n}_{2} + 1 , β = {N}_{2} - {n}_{2} + 1 and Γ is the gamma function . Note that H is normalized , i . e . {\sum }_{n 1 = 0}^{{N}_{1}} H ( {n}_{1} , {N}_{1} , {n}_{2} , {N}_{2} ) = 1.$$

The total background counts x_{g} and X_{g} for the gene can be calculated, given the background counts in the gene itself plus its bagel (note, it may be possible for a gene to have no genes in its bagel).

$${x}_{g} = {n}_{g}^{bkgd} + {\sum }_{i ∈ {B}_{g}} {n}_{i}^{bkgd}$$

$${X}_{g} = {N}_{g}^{bkgd} + {\sum }_{i ∈ {B}_{g}} {N}_{i}^{bkgd}$$

### Incorporation of Category- and Patient-Specific Rates

At 340, category- and patient-specific background mutation rates can be calculated and combined with the per-gene x_{g} and X_{g} background counts from the previous section. For example, mutations and coverage can be summed across the three zones to yield total counts:

n_{g,c,p}^{total}=n_{g,c,p}^{silent}+n_{g,c,p}^{nonsilent}+n_{g,c,p}^{noncoding}

N_{g,c,p}^{total}=N_{g,c,p}^{silent}+N_{g,c,p}^{nonsilent}+N_{g,c,p}^{noncoding}

Totals can be calculated across genes:

$${n}_{c , p}^{total} = {\sum }_{g = 1}^{{n}_{g}} {n}_{g , c , p}^{total}$$

$${N}_{c , p}^{total} = {\sum }_{g = 1}^{{n}_{g}} {N}_{g , c , p}^{total}$$

And across patients:

$${n}_{c}^{total} = {\sum }_{p = 1}^{{n}_{p}} {n}_{c , p}^{total}$$

$${N}_{c}^{total} = {\sum }_{p = 1}^{{n}_{p}} {N}_{c , p}^{total}$$

To yield marginal category-specific mutation rates:

$${μ}_{c} = \frac{{n}_{c}^{total}}{{N}_{c}^{total}}$$

And the overall total mutation rate:

$${n}_{overall}^{total} = {n}_{c + 1}^{total}$$

$${N}_{overall}^{total} = {N}_{c + 1}^{total}$$

$${μ}_{overall} = \frac{{n}_{overall}^{total}}{{N}_{overall}^{total}}$$

Patient-specific marginal mutation rates can be calculated:

$${n}_{p}^{total} = {n}_{c + 1 , p}^{total}$$

$${N}_{p}^{total} = {N}_{c + 1 , p}^{total}$$

$${μ}_{p} = \frac{{n}_{p}^{total}}{{N}_{p}^{total}}$$

And relative category- and patient-specific rates f can be calculated by normalizing to μₒᵥₑᵣₐₗₗ:

$${f}_{c} = \frac{{μ}_{c}}{{μ}_{overall}}$$

$${f}_{p} = \frac{{μ}_{p}}{{μ}_{overall}}$$

Also, the relative amounts of covered territory f^{N} per category and patient can be calculated. The category-specific territory can be normalized to the total overall territory, and the patient-specific territory can be normalized to the mean patient-specific territory.

$${f}_{c}^{N} = \frac{{N}_{c}^{total}}{{N}_{overall}^{total}}$$

$${f}_{p}^{N} = \frac{{N}_{p}^{total}}{\frac{1}{{n}_{p}} {N}_{overall}^{total}}$$

Finally, x_{g,c,p} and X_{g,c,p} can be estimated by the product of marginal relative rates and x_{g} and X_{g}:

x_{g,c,p}=x_{g}f_{c}fₚf_{c}^{N}fₚ^{N}

X_{g,c,p}=X_{g}f_{c}^{N}fₚ^{N}

Calculation of Gene p-Values Using 2-D Projection Method:

At 350, for each gene, the mutational signal from the observed nonsilent counts can be compared to the mutational background estimated above. In some embodiments, this can be done by calculating how likely it would be by chance for each sample to have a mutation in each of the categories:

P_{g,c,p}⁽⁰⁾=H(0,N_{g,c,p}^{nonsilent},x_{g,c,p},X_{g,c,p})

P_{g,c,p}⁽¹⁾=H(1,N_{g,c,p}^{nonsilent},x_{g,c,p},X_{g,c,p})

P_{g,c,p}⁽²⁺⁾=1−P_{g,c,p}⁽⁰⁾−P_{g,c,p}⁽¹⁾

H is the same beta-binomial probability mass function defined earlier. P_{g,c,p}⁽⁰⁾ is the probability that in this gene g, patient p, has zero mutations in category c. P_{g,c,p}⁽¹⁾ is the probability of exactly one mutation, and P_{g,c,p}^{(Z+)} is the probability of two or more.

Within each patient, mutation categories can be sorted into an order of priorities, e.g., according to P⁽¹⁾. In some embodiments, the categories can be sorted from the category most likely by chance (lowest priority), to the category least likely by chance (highest priority). Each patient can be projected to a two-dimensional space of degrees D_{g,p}=(d₁, d₂), taking into account up to two of its mutations, with the mutations prioritized by category as described, i.e., the two with the highest priorities (d₁≧d₂). For example, a sample of degree (1,0) has one mutation, and that mutation is of the lowest-priority category. A sample of degree (n_{c},0) has one mutation, and that mutation is of the highest-priority category. A sample of degree (n_{c}, n_{c}) has at least two mutations of the highest-priority category. Then, in order to compute the distribution of patient degrees expected under the estimated model of background mutation, the probability can be calculated for each patient to be of each degree by chance.

$${P}_{g , p}^{( {d}_{1} , {d}_{2} )} = \{ \begin{matrix}{\prod }_{d = 1}^{{n}_{c}} {P}_{g , d , p}^{( 0 )} , & \begin{matrix}if {d}_{1} = 0 , \\ {d}_{2} = 0\end{matrix} \\ {P}_{g , {d}_{1} , p}^{( 1 )} {\prod }_{d = 1}^{{d}_{1} - 1} {P}_{g , d , p}^{( 0 )} {\prod }_{d = {d}_{1} + 1}^{{n}_{c}} {P}_{g , d , p}^{( 0 )} , & \begin{matrix}if {d}_{1} > 0 , \\ {d}_{2} = 0\end{matrix} \\ {P}_{g , {d}_{1} , p}^{( 1 )} ( \begin{matrix}{P}_{g , {d}_{2} , p}^{( 1 )} + \\ {P}_{g , {d}_{2} , p}^{( 2 + )}\end{matrix} ) {\prod }_{d = {d}_{2} + 1}^{{d}_{1} - 1} {P}_{g , d , p}^{( 0 )} {\prod }_{d = {d}_{1} + 1}^{{n}_{c}} {P}_{g , d , p}^{( 0 )} , & \begin{matrix}if {d}_{1} > 0 , \\ 0 < {d}_{2} < {d}_{1}\end{matrix} \\ {P}_{g , {d}_{1} , p}^{( 2 + )} {\prod }_{d = {d}_{1} + 1}^{{n}_{c}} {P}_{g , d , p}^{( 0 )} , & \begin{matrix}if {d}_{1} > 0 , \\ {d}_{2} = {d}_{1}\end{matrix} \\ 0 ( impossible by definition ) , & if {d}_{2} > {d}_{1}\end{matrix}$$

Each degree can also be associated with a score S.

$${S}_{g , p}^{( {d}_{1} , {d}_{2} )} = \{ \begin{matrix}0 , & if {d}_{1} = 0 , {d}_{2} = 0 \\ {S}_{null} - {log}_{10} {P}_{g , {d}_{1} , p}^{( 1 )} , & if {d}_{1} > 0 , {d}_{2} = 0 \\ {S}_{null} - {log}_{10} {P}_{g , {d}_{1} , p}^{( 1 )} - {log}_{10} {P}_{g , {d}_{2} , p}^{( 1 )} , & if {d}_{1} > 0 , 0 < {d}_{2} < {d}_{1} \\ {S}_{null} - {log}_{10} {P}_{g , {d}_{1} , p}^{( 2 + )} , & if {d}_{1} > 0 , {d}_{2} = {d}_{1} \\ 0 ( impossible by definition ) , & if {d}_{2} > {d}_{1}\end{matrix}$$

where Sₙᵤₗₗ represents the null score boost added to scores associated with the presence of a null mutation, reflecting the increased value of a null mutation towards the total evidence of a gene's driver potential.

$${S}_{null} = \{ \begin{matrix}0 , & if {d}_{1} < {n}_{c} \\ + 3 , & if {d}_{1} = {n}_{c}\end{matrix}$$

The gene can be assigned a total overall score for the observed configuration of patient degrees, e.g., by summing the scores associated with the observed degree D of each patient.

$${S}_{g}^{obs} = \frac{{\sum }_{p = 1}^{{n}_{p}} {S}_{g , p}^{{D}_{g , p}}}{{E}_{min}}$$

Where Eₘᵢₙ is the minimum effect size considered sufficient evidence for positive selection in the gene. A value of Eₘᵢₙ=1.25 is used, corresponding to a required +25% effect size. Smaller effect sizes are treated as falling within the noise regime of the data. Using Eₘᵢₙ is to protect against residual uncertainty in the background mutation model, even beyond the uncertainty due to stochastic sampling. This uncertainty is particularly large at the high end of the mutation rate spectrum. In certain embodiments, the model includes quantitatively estimating the magnitude of uncertainty based on each gene's covariates, and choosing a gene-specific Eₘᵢₙ accordingly.

In order to determine the probability of obtaining a given score by chance, i.e. from background mutation alone, a null distribution of scores is calculated by convolution. First, within each individual patient p, the null distribution of scores for that patient is computed by convoluting the probabilities and scores of each possible degree

$${P}_{g , p}^{( S = x )} = {{⊗}_{{d}_{1} = 0}}^{{n}_{c}} { {⊗}_{{d}_{2} = 0}}^{{n}_{c}} {P}_{g , p}^{( {d}_{1} , {d}_{2} )} δ ( x - {S}_{g , p}^{( {d}_{1} , {d}_{2} )} )$$

where δ is the Dirac delta function. Then, the distributions for each patient are convoluted together to obtain the overall null distribution for the gene.

$${P}_{g}^{( S = x )} = {{⊗}_{p = 1}}^{{n}_{p}} {P}_{g , p}^{( S = x )}$$

The p-value of the gene, i.e. the probability of obtaining at least the observed score by chance, can be given by:

$${P}_{g}^{( S \geq {S}^{obs} )} = {\int }_{{S}_{g}^{obs}}^{∞} {P}_{g}^{( S = x )} d x$$

In some embodiments, it may be easier to compute this by calculating the probability of obtaining less than the observed score and subtracting from one.

$${P}_{g}^{( S \geq {S}^{obs} )} = 1 - {\int }_{0}^{{S}_{g}^{obs}} {P}_{g}^{( S = x )} d x$$

### Calculation of False Discovery Rate:

At 360, each gene can be assigned a q-value, i.e. False Discovery Rate. In some embodiments, the method of Benjamini and Hochberg (Benjamini, Y. H. (1995) “Controlling the false discovery rate: a practical and power approach to multiple testing.” J. Royal Statistical Society Series B 57, 289, the contents of which are incorporated herein by reference) can be employed. For example, genes with q≦0.1 can be considered to be significantly mutated.

### Output Data:

At 370, an output can be generated. In some embodiments, the output can be a table listing the genes with their p- and q-values, e.g., ordered by p-value.

Although patients and cancer genes are provided in the above description, these are merely used as examples for illustrative purposes only. The present subject matter can also be utilized to determine, one or more gene mutations (e.g. good and/or bad), for example, in plants, mammals, and other subjects containing genes and mutations. For example, the present subject matter may be used to determine the significantly mutated genes in a plant that has a certain desirable trait.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

With certain aspects, to provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A computer-implemented method for identifying one or more significantly mutated genes, the method comprising:
providing a first dataset comprising one or more mutations detected in a sequencing project comprising one or more genes and one or more subjects;
providing a second dataset comprising a sequencing coverage achieved for each of the genes and the subjects;
providing a third dataset comprising one or more genomic covariate data for each of the genes; and
determining a false discovery rate for each of the genes to identify the one or more significantly mutated genes.

2. The method according to claim 1, wherein determining a false discovery rate for each of the genes comprises:
calculating a p-value for each gene; and
determining a false discovery rate for each of the genes by converting the p-values to q-values;
wherein genes with about q≦0.1 are identified as the one or more significantly mutated genes.

3. The method according to claim 1, further comprising estimating local mutation rates for the genes.

4. The method according to claim 3, wherein the local mutation rates are estimated by converting each covariate to a centered and normalized score.

5. The method according to claim 1, further comprising estimating a local background mutation rate for each of the genes.

6. The method according to claim 5, wherein the local background mutation rate is estimated from silent and/or noncoding mutations of each of the genes itself.

7. The method according to claim 6, wherein the local background mutation rate is estimated additionally from one or more neighbor genes in a covariate space.

8. The method according to claim 5, further comprising determining a patient specific background mutation rate by combining the local background mutation rates for each of the subjects.

9. The method according to claim 8, further comprising determining a probability for each sample to have a mutation in one or more categories.

10. The method according to claim 9, wherein the false discovery rate is determined from the determined probability for each sample to have a mutation in one or more categories.

11. The method according to claim 10, further comprising generating an output including the determined probabilities and the false discovery rates.

12. A computer-implemented method for identifying one or more significantly mutated genes, the method comprising:
providing a plurality of genes from samples from a plurality of patients, the plurality of genes comprising a plurality of mutations;
scoring each mutation against a corresponding patient-specific background rate μₚ to obtain a gene score for each mutation;
determining a null distribution for each gene score by convoluting across patients the patient-specific null distribution based on the μₚ;
summarizing one or more events by projecting to a space of degrees corresponding to one or more categories of mutations based on a frequency of occurrence; and
determining a probability for each sample to be of a particular degree based on the μₚ.

13. The method according to claim 12, further comprising determining one or more p-values for mutation abundance for each gene.

14. The method according to claim 13,
wherein the determining of one or more p-values comprises determining a clustering p-value (pCL) by randomly permuting one or more observed mutations one or more times and measuring a fraction of permutations in which one or more permuted mutations are at least as clustered in configuration as the observed mutations or
further comprising determining a functional impact p-value (pFN) by randomly permuting one or more observed mutations one or more times and measuring a fraction of permutations in which the permuted mutations are at least as enriched in one or more functionally important sites in the respective gene as the one or more observed mutations or
wherein a plurality of the p-values are determined, the method further comprising combining the plurality of p-values into a single summary metric p-value.

15. A computer-implemented method for identifying one or more significantly mutated genes, the method comprising:
placing a plurality of genes in a covariate space;
selecting a first gene from the plurality of genes and identifying one or more closest neighbors of the first gene in the covariate space; and
determining a local background mutation rate of the one or more closest neighbors, excluding the first gene.

16. The method according to claim 15,
further comprising identifying one or more additional closest neighbors and determining an additional local background mutation rate of the one or more closest neighbors and the additional closest neighbors or
further comprising determining a gene-specific contribution to the background mutation rate using a frequency of synonymous and noncoding mutations in the first gene plus its closest neighbors.

17. A non-transitory computer readable medium comprising computer-executable instructions recorded thereon for causing a computer to perform the method comprising:
providing a first dataset comprising one or more mutations detected in a sequencing project comprising one or more genes and one or more subjects;
providing a second dataset comprising a sequencing coverage achieved for each of the genes and the subjects;
providing a third dataset comprising one or more genomic covariate data for each of the genes; and
determining a false discovery rate for each of the genes to identify the one or more significantly mutated genes.

18. The non-transitory computer readable medium according to claim 17,
wherein the method further comprises estimating local mutation rates for the genes or
wherein the local mutation rates are estimated by converting each covariate to a centered and normalized score.

19. The non-transitory computer readable medium according to claim 17, wherein the method further comprises estimating a local background mutation rate for each of the genes.

20. The non-transitory computer readable medium according to claim 19, wherein the local background mutation rate is estimated from silent and/or noncoding mutations of each of the genes itself.

21. The non-transitory computer readable medium according to claim 20, wherein the local background mutation rate is estimated additionally from one or more neighbor genes in a covariate space.

22. The non-transitory computer readable medium according to claim 19, wherein the method further comprises determining a patient specific background mutation rate by combining the local background mutation rates for each of the subjects.

23. The non-transitory computer readable medium according to claim 22, wherein the method further comprises determining a probability for each sample to have a mutation in one or more categories.

24. The non-transitory computer readable medium according to claim 23, wherein the false discovery rate is determined from the determined probability for each sample to have a mutation in one or more categories.

25. A non-transitory computer readable medium comprising computer-executable instructions recorded thereon for causing a computer to perform the method comprising:
providing a plurality of genes samples from a plurality of patients, the plurality of genes comprising a plurality of mutations;
scoring each mutation against a corresponding patient-specific background rate μₚ to obtain a gene score for each mutation;
determining a null distribution for each gene score by convoluting across patients the patient-specific null distribution based on the μₚ;
summarizing one or more events by projecting to a space of degrees corresponding to one or more categories of mutations based on a frequency of occurrence; and
determining a probability for each sample to be of a particular degree based on the μₚ.

26. The non-transitory computer readable medium according to claim 25, further comprising determining one or more p-values for mutation abundance for each gene.

27. The non-transitory computer readable medium according to claim 26,
wherein the determining of one or more p-values comprises determining a clustering p-value (pCL) by randomly permuting one or more observed mutations one or more times and measuring a fraction of permutations in which one or more permuted mutations are at least as clustered in configuration as the observed mutations or
further comprising determining a functional impact p-value (pFN) by randomly permuting one or more observed mutations one or more times and measuring a fraction of permutations in which the permuted mutations are at least as enriched in one or more functionally important sites in the respective gene as the one or more observed mutations or
wherein a plurality of the p-values are determined, the method further comprising combining the plurality of p-values into a single summary metric p-value.

28. A non-transitory computer readable medium comprising computer-executable instructions recorded thereon for causing a computer to perform the method comprising:
placing a plurality of genes in a covariate space;
selecting a first gene from the plurality of genes and identifying one or more closest neighbors of the first gene in the covariate space; and
determining a local background mutation rate of the one or more closest neighbors, excluding the first gene.

29. The non-transitory computer readable medium according to claim 28,
further comprising identifying one or more additional closest neighbors and determining an additional local background mutation rate of the one or more closest neighbors and the additional closest neighbors or
further comprising determining a gene-specific contribution to the background mutation rate using a frequency of synonymous and noncoding mutations in the first gene plus its closest neighbors.
